(19) United States
(12) Patent Application Publication
(10) Pub. No.: US 2026/0190038 A1
(43) Pub. Date: Jul. 2, 2026

(54) INFORMATION DELIVERY FOR COORDINATED SPATIAL REUSE

(71) Applicant: Cisco Technology, Inc., San Jose, CA (US)

(72) Inventors: Brian D. HART, Sunnyvale, CA (US); Vishal S. DESAI, San Jose, CA (US); Binita GUPTA, San Diego, CA (US)

(21) Appl. No.: 19/281,602

(22) Filed: Jul. 26, 2025

Related U.S. Application Data
(60) Provisional application No. 63/740,224, filed on Dec. 30, 2024.

(51) Int. Cl. H04W 52/24; H04B 17/318; H04W 12/0431; H04W 12/106

(52) U.S. Cl. CPC H04W 52/242; H04B 17/318; H04W 12/0431; H04W 12/106

(57) ABSTRACT

Techniques and apparatus for providing information to an AP within a wireless network are described. An example technique includes sending a first frame to a first wireless device, the first frame comprising a first control field indicating a first one or more parameters of the first frame, at least one parameter of the first one or more parameters is associated with a transmit power of the AP. Receiving a second frame from the first wireless device, the second frame is carried in a physical layer PPDU and comprises a second control field indicating a second one or more parameters of the first frame, at least one parameter of the second one or more parameters is associated with a pathloss determined based on the at least one parameter and a RSSI measured by the first wireless device. Extracting the pathloss reported in the second frame.

### CROSS-REFERENCE TO RELATED APPLICATIONS

This application claims benefit of co-pending U.S. provisional patent application Ser. No. 63/740,224 filed Dec. 30, 2024. The aforementioned related patent application is herein incorporated by reference in its entirety.

### TECHNICAL FIELD

Embodiments presented in this disclosure generally relate to obtaining information from stations in a wireless network. More specifically, embodiments disclosed herein relate to an access point efficiently obtaining and sending reports to and from stations coupled to a wireless network.

### BACKGROUND

Coordinated special reuse (Co-SR) enhances Wi-Fi 8 by enabling simultaneous transmissions between access points (APs) with sufficient isolation. Received signal strength indicator (RSSI) measurements are crucial for APs to coordinate special reuse effectively within the same channel. Thus, it is important to get good information of the RSSI between various players in the wireless network, in particular, when there may be multiple different basic service sets (BSSs) of interest (e.g., at 2.4 gigahertz (GHz) or with wider bandwidths, such as at 5 or 6 GHZ).

Currently, there are limitations on the flexibility of control fields that impact information transmission efficiency. Thus, there is a need for a low overhead protocol to deliver the information (e.g., for IEEE 802.11 networking standards).

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a representative AP architecture, according to one or more embodiments of the present disclosure.

FIG. 2A depicts an ultra-high reliability multi-user physical protocol data unit (UHR MU PPDU), according to one or more embodiments of the disclosure.

FIG. 2B depicts an aggregate MAC protocol data unit (A-MPDU), according to one or more embodiments of the disclosure.

FIG. 3 illustrates a schematic block diagram of a control information field format conveying various parameters, according to one or more embodiments of the disclosure.

FIG. 4 illustrates two overlapping basic service sets (BSSs), according to one or more embodiments of the present disclosure.

FIGS. 5A-5L illustrates various information delivery processes of information delivery for conveying various parameters within the two overlapping BSSs of FIG. 4, according to one or more embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure a method of providing information to an access point (AP), the method comprising sending a first frame to a first wireless device, the first frame comprising a first control field indicating a first one or more parameters of the first frame, wherein at least one parameter of the first one or more parameters is associated with a transmit power of the AP; receiving a second frame from the first wireless device, wherein the second frame is carried in a physical layer protocol data units (PPDU) and comprises a second control field indicating a second one or more parameters of the first frame, wherein at least one parameter of the second one or more parameters is associated with a pathloss determined based on the at least one parameter of the first one or more parameters and a received signal strength indicator (RSSI) measured by the first wireless device; and extracting the pathloss reported in the second frame.

In another embodiment, a method of providing information to an access point (AP), the method comprising intercepting one or more physical layer protocol data units (PPDUs), wherein at least one frame in a PPDU of the one or more intercepted PPDUs is addressed to a different AP or a client for identification purposes but intended for the AP, each of the at least one frame in the PPDU comprises a control field, and the control field of each intercepted PPDU indicates one or more of: a conducted transmit power of an associated intercepted PPDU; a radiated transmit power of an associated intercepted PPDU; a received signal strength indicator (RSSI) of an associated intercepted PPDU; a pathloss of an associated intercepted PPDU; and a signal-to-interference ratio (SIR) of an associated intercepted PPDU.

In yet another embodiment, a access point (AP) multilink device (MLD) comprising one or more memories collectively storing instructions; and one or more processors communicatively coupled to the one or more memories, the one or more processors being individually or collectively configured to execute the instructions to cause the AP MLD to perform an operation comprising sending a first frame to a first wireless device, the first frame comprising a first control field indicating a first one or more parameters of the first frame, wherein at least one parameter of the first one or more parameters is associated with a transmit power of the AP; receiving a second frame from the first wireless device, wherein the second frame is carried in a PPDU and comprises a second control field indicating a second one or more parameters of the first frame, wherein at least one parameter of the second one or more parameters is associated with a first pathloss determined based on the at least one parameter of the first one or more parameters and a received signal strength indicator (RSSI) measured by the first wireless device; intercepting a third frame, the third frame is addressed to a different AP or a different client for identification purposes but intended for the AP; extracting the first pathloss based reported in the second frame; and extracting a second pathloss associated with the different AP or different client based on the third frame.

### EXAMPLE EMBODIMENTS

Coordinated spatial reuse (Co-SR) allows for the coordination of two or more APs to transmit or receive at the same time as long as there is sufficient isolation (e.g., pass loss isolation). In circumstances where there is interference between two APs and/or between clients associated with either one of the APs, but not enough interference that communication between any of the various players is blocked, modulation and coding schemes (MCSs) may be relied upon to facilitate communication despite the interference.

In Wi-Fi8, with Co-SR, it is important to get good information of the RSSI(s) between various players in the wireless network, in particular, when there may be multiple different BSSs of interest (e.g., at 2.4 GHz or with wider bandwidths, such as at 5 or 6 GHz). In an example of such a scenario, a first AP can learn the RSSI or pathloss arising from transmitting (1) from the first AP to a second AP and vice versa, (2) from the first AP to a client of the first AP and vice versa, (3) from the second AP to a client of the second AP and vice versa, (4) from the first AP to a client of the second AP and vice versa, (5) from the second AP to a client of the first AP and vice versa, and (6) from the client of the first AP to a client of the second AP and vice versa. There is a need for a low overhead protocol to deliver the information (e.g., for the IEEE 802.11 wireless local area networking standard and its amendments) associated with the aforementioned scenarios.

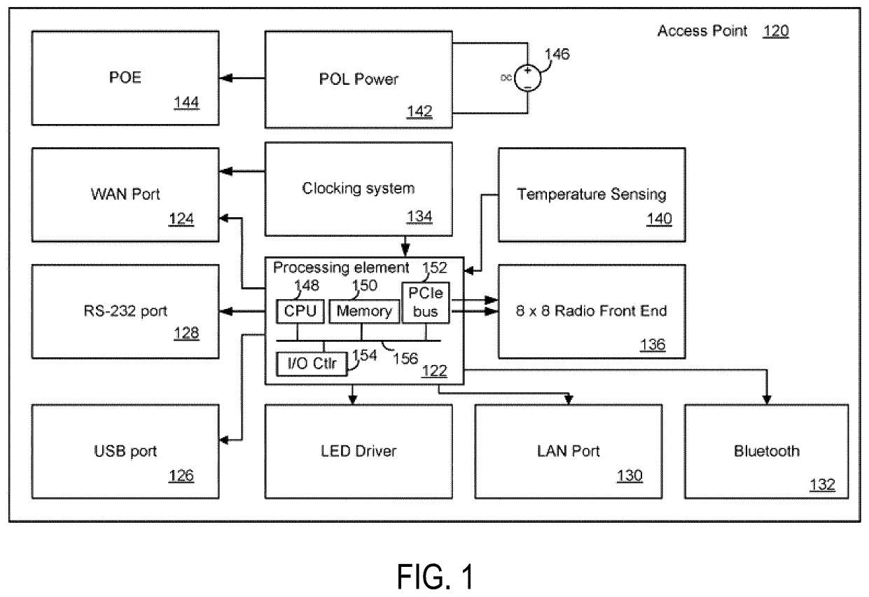

FIG. 1 depicts a representative architecture of an AP. The access point 120 includes a processing element 122 and several ports or connection facilities, such as a WAN port 124, USB port 126, RS-232 port 128, LAN port 130, and Bluetooth 132. Also included are a clocking system 134 and an 8×8 radio front-end 136 with a transmitter and receiver, which are coupled to eight external antennas. Auxiliary modules include a temperature sensing module 140, a power module 142 connected to a DC power source 146, and a power over Ethernet (POE) module 144. The processing system includes a CPU 148 and memory 150, a peripheral component interconnect express (PCIe) bus controller 152 for connecting to the radio front-end 136, and an I/O controller 154, all coupled to each other via bus 156.

The AP implements the physical layer of 802.11bn (i.e., Wi-Fi 8) specification, adding two new features to the wireless protocol: multi-user, multiple-input, multiple-output (MU-MIMO) radio links, and orthogonal frequency division multiple access (OFDMA) modulation.

MU-MIMO allows parallelism in the spatial domain. In MU-MIMO, multiple transmitters and receivers can operate simultaneously during the same transmission opportunity (TXOP). MU-MIMO supports up to 8 simultaneous transmissions and is well-suited to large data packets.

In OFDMA, the spectrum is organized into a set of operating channels. Each channel comprises subcarriers, with some of the subcarriers used as pilot carriers and the others for carrying data. Each subcarrier (called a tone) is modulated by quadrature amplitude modulation (QAM). In addition, the subcarriers of a channel are assigned to groups called resource units (RUs), which can be operated independently of each other. Thus, a 20 MHz channel can communicate with a single station or client or up to nine stations or clients simultaneously, each having its own RU. The number of simultaneous transmissions can vary per TXOP.

To handle the new capabilities of OFDMA and MU-MIMO, a number of new data frames, called High Efficiency (HE) frames, are included in the protocol standard.

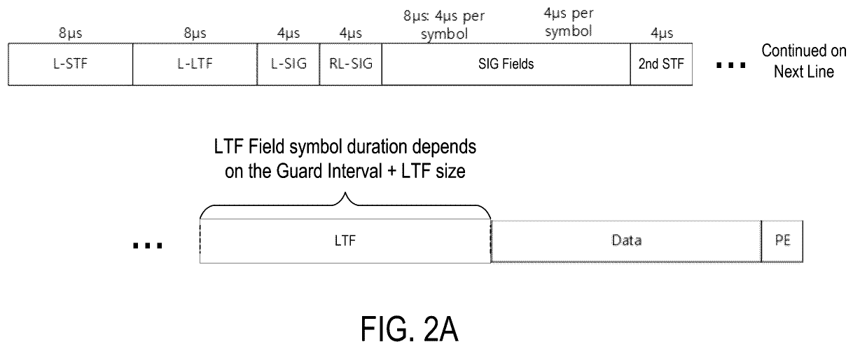

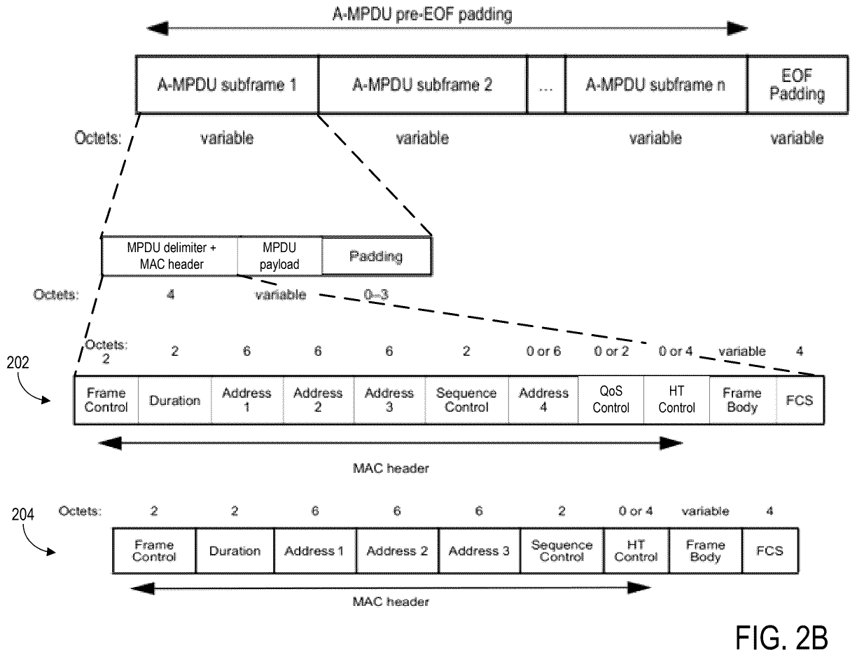

FIG. 2A depicts an ultra-high reliability multi-user physical protocol data unit (UHR MU PPDU), according to one or more embodiments of the disclosure. UHR MU PPDU enables transmissions to one or more users simultaneously, supporting both non-orthogonal frequency division multiple access (OFDMA) (e.g., traditional multi-user multi-input multi-output (MIMO)) and OFDMA methods. The UHR MU PPDU includes a legacy short training field (L-STF), a legacy long training field (L-LTF), a legacy signal field (L-SIG), a repeat legacy signal field (RL-SIG), signal fields (SIG fields), a long training field (LTF), a data section, and a packet extension (PE). The duration (in microseconds) of each of the fields is denoted above the respective fields. The duration of the LTF field duration depends on a guard interval and size of the LTF.

FIG. 2B depicts an aggregate MAC protocol data unit (A-MPDU), according to one or more embodiments of the disclosure. An A-MPDU enables the packing of many frames into a single PHY Protocol Data Unit (PPDU), increasing MAC efficiency by reducing the number of preambles and inter-frame spacings. In the example shown, the A-MPDU includes one or more A-MPDU subframes (e.g., A-MPDU subframe 1, 2, A-MPDU n, etc.) and end of frame (EOF) padding. Each A-MPDU subframe includes a MPDU delimiter and MAC header, a MPDU payload (data), and padding for alignment. In one or more examples, the MAC header includes a data frame format 202. In one or more examples, the MAC header includes a management frame format 204 (e.g., a beacon frame).

The data frame format 202 and management frame format 204 include various fields, such as a frame control (2 octets); a duration (2 octets); one or more address fields (each 6 octets); a sequence control (2 octets); one or more optional fields such as a quality of service (QOS) control and/or a high-throughput (HT) control; a frame body (variable length); and a frame check sequence (FCS, 4 octets).

Table 1 depicted below captures the layout of HT Control field's 32-bit segment across various Wi-Fi standards (HT, very high throughput (VHT), and high efficiency (HE)), showing how control information has evolved and how new capabilities were introduced to improve medium access control, traffic prioritization, and frame coordination—which are essential for supporting higher throughput, better QoS, and more efficient multi-user operation in modern Wi-Fi networks. In some embodiments, a recommended MCS, buffer status report (BSR) and headroom feedback is conveyed in the HT Control field. Specifically, the HE variant of the HT control field includes an advanced control (A-Control) field which in turn includes a control list, which is made up of one or more control fields each comprising a 4 bit control field followed by a variable-length control information field. The variable-length control information field may be used to carry uplink (UL) power headroom or a BSR as discussed above. Given that there is one HT control field per frame and an AMPDU may include one or more frames, it is possible to carry one or more different parameters in the same physical layer protocol data unit (PPDU) from one STA to another. The shorter the control fields, the more that can be packed into a given A-Control field. Currently, the uplink (UL) headroom control field comprises 4 bit control identification (ID) plus 12 bit control information.

TABLE 1
HT Control Field Format

| Variant | B0 | B1 | B2-B29 | B30 | B31 |
|---|---|---|---|---|---|
| HT | 0 | HT Control Middle | | AC | Reverse Direction |
| | | | | Constraint | Grant/More PPDU |
| VHT | 1 | 0 | VHT Control | AC | Reverse Direction |
| | | | Middle | Constraint | Grant/More PPDU |

| | | | |
|---|---|---|---|
| HE | 1 | 1 | A-Control |

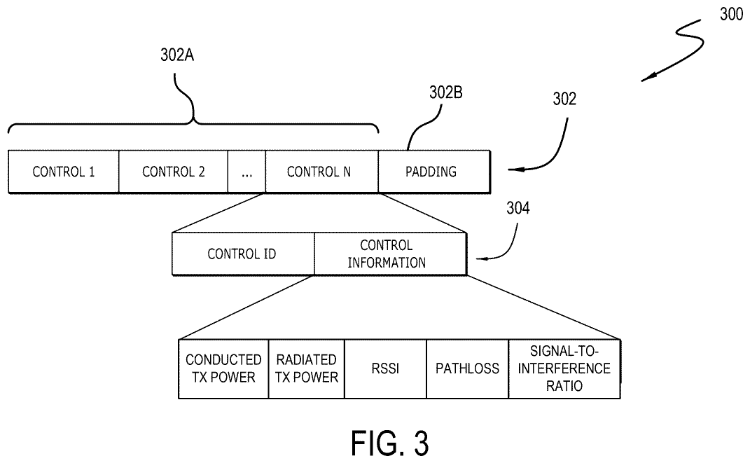

FIG. 3 illustrates a schematic block diagram of a control information field format 300 conveying various parameters, according to one or more embodiments of the disclosure. In some embodiments, the control information field format 300 may be configured to indicate radio frequency (RF) information by conveying various parameters to efficiently express RSSI, pathloss, TX power, signal-to-interference ratio (SIR), or a combination thereof. The control information field format may be implemented into an MPDU transmitted among APs/STAs (e.g., AP to AP, AP to STA, STA to AP, and/or STA to STA). A frame including the control information field may be transmitted from a wireless device, such as an AP, to a wireless device, such as a STA. Similarly, the STA may also transmit RF information to the AP by sending frames implementing the control information field format 300. In another embodiment the A-Control field or control list is defined to be included in one or more control frames.

The control information field format 300 may be utilized for indicating RF information by conveying parameters associated with RSSI, pathloss, transmit (TX) power, SIR, or a combination thereof. In a variety of embodiments, the control information field format 300A may include an A-Control subfield 302 of an HE variant HT control field. The A-Control subfield 302 may include a control list 302A with a sequence of one or more control fields 304, for example, Control 1, Control 2, . . . , Control N, and a padding subfield 302B. In various embodiments, the control list 302A may extend to a variable number of bits, and the padding subfield 302B may extend to 0 or more bits. Each control field 304 may include a control identifier (ID) subfield and a control information subfield. The control information subfield may carry control information that depends on a control ID value indicated in the control ID subfield. The padding subfield 302B may follow the last control subfield and may be set to a sequence of bits, such as zero bits, to ensure the length of the A-Control subfield 302 carried in the HT control field is, for example, 30 bits.

In certain embodiments, the control information subfield may include a conducted TX power subfield, a radiated TX power subfield, a RSSI subfield, a pathloss subfield, a SIR subfield, or a combination thereof.

In certain embodiments, the capability to receive (and in other embodiments, to transmit as well) RF information (e.g., parameters associated with RSSI, pathloss, TX power, SIR) may be signaled in 802.11bn as part of the Ultra High Reliability (UHR) capabilities element or another element/field. Additionally, in certain embodiments, the AP may signal the UHR capabilities element (e.g., including the support for RF information transmission/reception) in management frames such as beacon, probe response, and (re) association response, and/or other management frame(s). In certain embodiments, the STA may signal the UHR capabilities (e.g., including the support for RF information transmission/reception) in management frames such as probe request, (re) association request and/or other management frame(s).

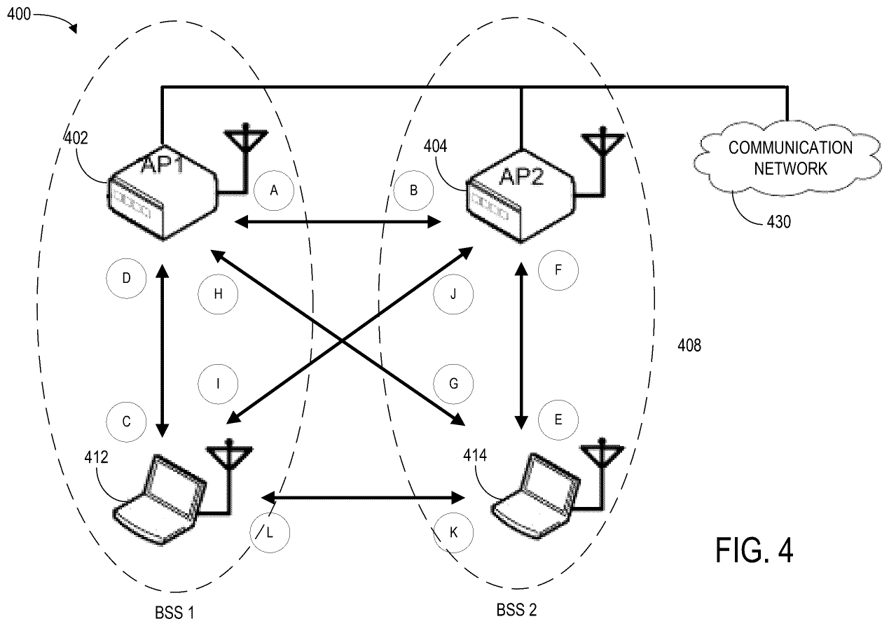

FIG. 4 illustrates two overlapping BSSs 400, according to one or more embodiments of the present disclosure. Communication network 320 can include wired networks or wireless networks. In various embodiments, the communication network 320 may be a Wi-Fi network operating on various frequency bands, such as, 2.4 GHz, 5 GHZ, or 6 GHz. APs (e.g., AP1 402 and AP2 404) and facilitates Wi-Fi connections for various electronic devices (e.g., STA1 412 and STA2 414), for example, mobile computing devices such as, but not limited to, laptop computers, cellular phones, portable tablet computers, and wearable computing devices. In many embodiments, a network management logic can be configured as a standalone device, exist as a logic in another wireless device, be distributed among various wireless devices operating in tandem, remotely operated as part of a cloud-based network management tool, or implemented in a computing device (e.g., a AP or controller).

The two overlapping BSSs 400 includes a first AP (e.g., AP1 402), a second AP (e.g., AP2 404), a first client (e.g., STA1 412), and a second client (e.g., STA2 414). In some embodiments, AP1 402 and STA1 412 define a first BSS (e.g., BSS1). In some embodiments, AP2 404 and STA2 414 define a second BSS (e.g., BSS2). It is to be noted that the two overlapping BSSs 400 may comprise any suitable number of APs connected to any suitable number of STAs and is thus not limited to the exemplary embodiment depicted in FIG. 4.

An AP may transmit RF information by conveying various parameters associated with RSSI, pathloss, transmit TX power, SIR, or a combination thereof to a STA. To transmit the RF information to the STA, in certain embodiments, the AP may generate a MPDU indicating the RF information, and transmit the MPDU to the STA. In certain embodiments, the MPDU may be configured to indicate the conducted TX power, the radiated TX power, RSSI, pathloss, SIR information, or a combination thereof in a control field of the MPDU. In certain embodiments, the MPDU may be a management frame, a data frame and even a control frame, or a beacon frame. In certain embodiments, a STA may transmit RF information by conveying various parameters associated with RSSI, pathloss, transmit TX power, SIR, or a combination thereof to an AP. To transmit the RF information to the AP, in certain embodiments, the STA may generate a frame, e.g., a management frame or control frame, including the various parameters indicating the RF information in a control field of the frame and transmit the frame to the STA. One or more examples further include from AP to AP, from AP to STA, and from STA to STA communications.

The process of Co-SR relies on measuring RSSI and understanding pathloss between wireless devices in the network (e.g., the two overlapping BSSs 400) for effective communication. Since pathloss is reciprocal between two devices, measurement of pathloss requires knowledge of both transmit power and RSSI, and given pathloss and transmit power then RSSI can be determined, by configuring the control information field of transmissions (e.g., frames) between the wireless devices in the network to indicate various parameters like TX power, pathloss, and SIR, the context by which to measure the RSSI is provided. For example, since TX power minus pathloss equals RSSI (i.e., TX power−pathloss=RSSI), when RSSI is measured, and TX power is provided, then pathloss can be determined. Further, to avoid burning control ID values, it is assumed that 1 to 2 control ID values are allocated to indicate “measurements” (in a typical 8 bit embodiment of the control information field), 1 to 2 bits of the control information field are defined to identify the specific measurement, and either (a) 6 to 7 bits are defined for the measurement or (b) the 6 to 7 bits of “(a)” are lowered/compressed by 1 to 2 bits to provide room for extra context (e.g., more information about measurements or the source of the measurements). It is worth noting that accurate calibration of both transmit power and RSSI is essential for reliably calculating pathloss and related/dependent parameters, but that it may be that a device has better RSSI or better TX power calibration.

At minimum, in the two overlapping BSSs 400 there are six wireless channels—denoted by a double arrow line. In a more extensive ESS, this pattern is replicated for other STAs and/or APs. That is, each wireless channel supports transmission by the wireless device at either end of the wireless channel. That is, on the same wireless channel, a transmission may be made from AP2 to AP1 and from AP1 to AP2, each indicated by one side of the double arrow line. Thus, there are twelve different combinations of transmissions between the wireless devices of the two overlapping BSSs 400. For reciprocity, the pathloss over the same wireless channel is the same so that the RSSI only differs by the amount that TX powers differ, so that shortcut can be exploited. For example, if the RSSI over the same wireless channel is the same, then the TX powers will also be the same. Further, if one TX power (dB) is higher by a value, then the RSSI from that transmission will also be higher by the same value.

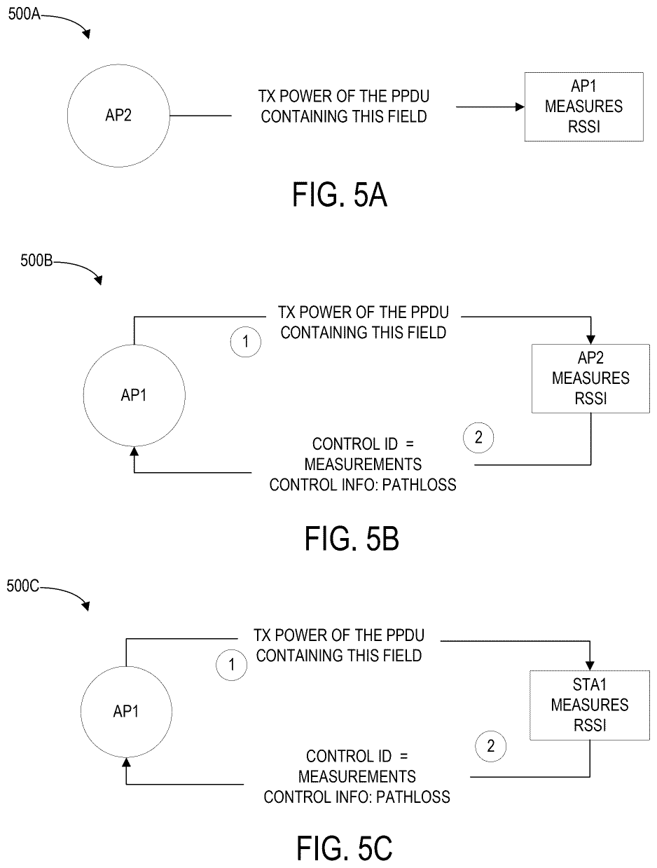

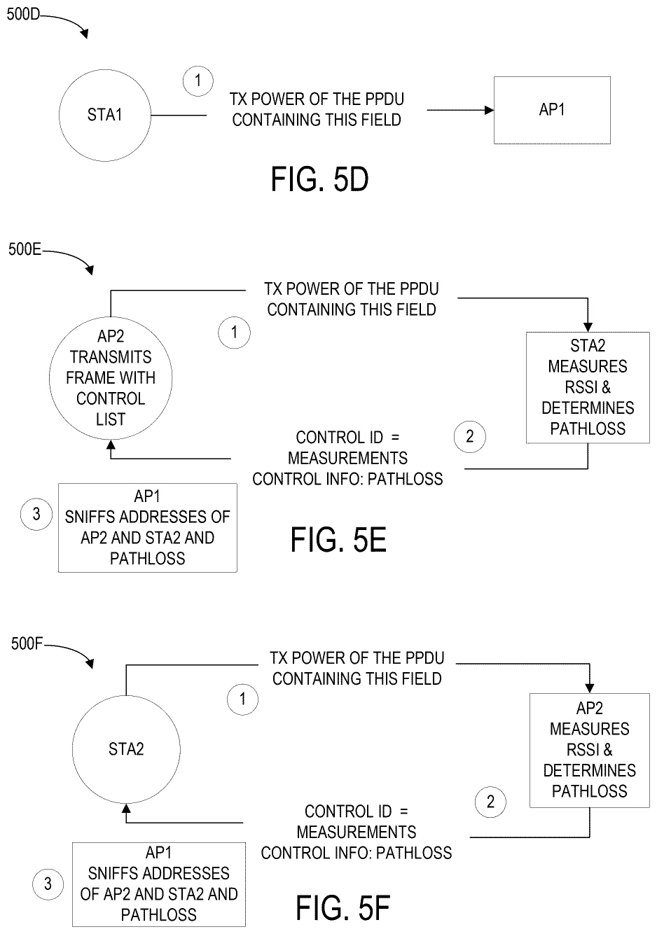

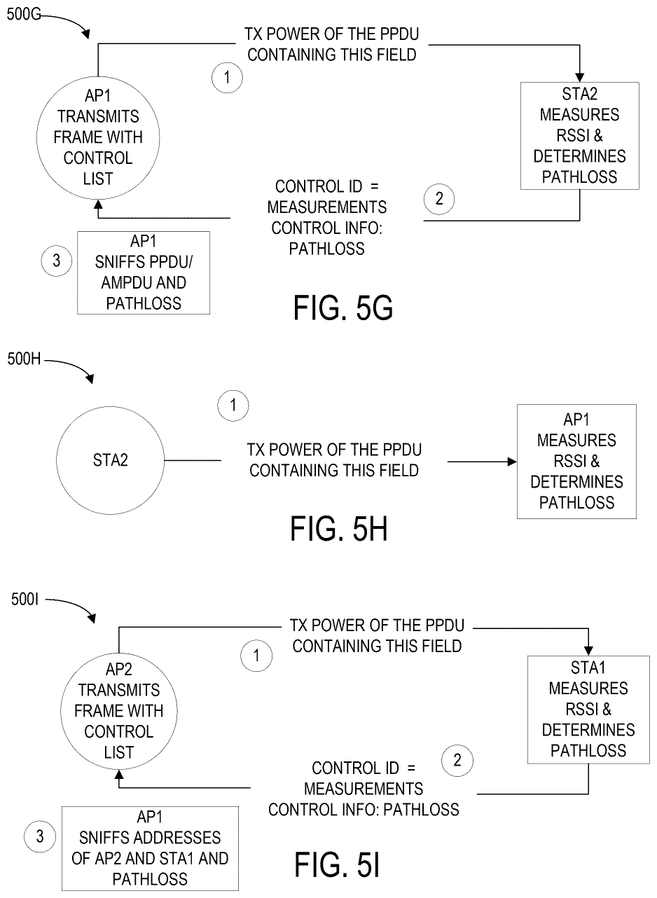

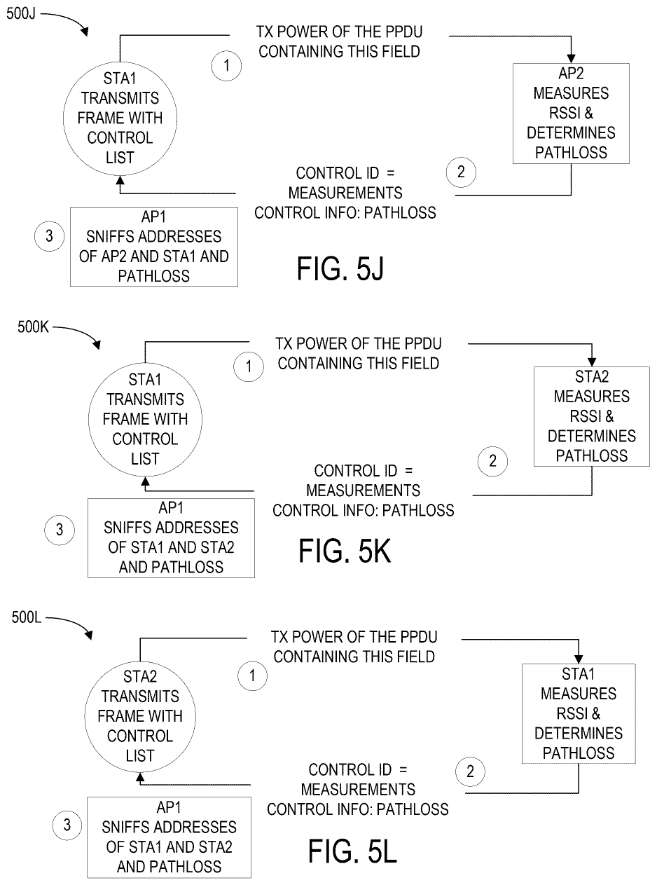

FIGS. 5A-5L illustrate various information delivery processes 500A, 500B, 500C, 500D, 500E, 500F, 500G, 500H, 500I, 500J, 500K, 500L of information delivery for conveying various parameters within the two overlapping BSSs 400 of FIG. 4, according to one or more embodiments of the present disclosure. Schemes A, B, C, D, E, F, D, H, I, J, K, and L (denoted by the circled letters in FIG. 4), indicates a process of information delivery between two devices of the two overlapping BSSs 400. For example, scheme A denotes an information delivery process 500A from AP2 to AP1, whereas scheme B is an information delivery process 500B from AP1 to AP2.

FIG. 5A depicts an information delivery process 500A between AP2 404 and AP1 402. AP2 404 transmits a PPDU to AP1 404. An MPDU within the PPDU has a control field (e.g., control field 304) that includes a control ID indicating measurements and a control information field indicating the TX power of the PPDU. AP1 402 then measures the RSSI and is then able to calculate the pathloss based on the TX power indicated by the PPDU.

FIG. 5B depicts an information delivery process 500B between AP1 402 and AP2 404. At step 1, AP1 402 transmits a first PPDU to AP2 404. A MPDU within the first PPDU has a control field that includes a control ID indicating measurements and a control information field indicating the TX power of the first PPDU. AP2 404 then measures the RSSI and is then able to calculate the pathloss based on the TX power indicated by the first PPDU. At step 2, AP2 404 transmits a second PPDU to AP1 402. A second MPDU within the second PPDU has a control field that includes a control ID indicating measurements and a control information field indicating the pathloss, given that TX power was received in the first PPDU from which RSSI was measured. That is, in the case that either (1) the address of AP1 402 was included in a transmission of AP2 404 or (2) a transmission of AP2 404 immediately follows the transmission of AP1 402 and the address of AP1 402 was thereby implied.

It is to be noted that information delivery process 500B competes with information delivery process 500A and can instead be used reciprocally, i.e., AP1 402 to AP2 404 and AP2 404 to AP1 402. Accordingly, each AP can measure the pathloss since each AP knows their own TX power and can infer the RSSI of their transmissions at the peer AP. The same may occur in reference to information delivery process 500C (described below), if STA1 412 transmits the TX power of STA1 412 to AP1 402. These workarounds may be valuable when, for example, an associated TX power—but not RSSI—is badly calibrated or vice versa. In another example, these workarounds may be valuable to learn about such miscalibration issues and/or for performing averaging.

FIG. 5C depicts an information delivery process 500C between AP1 402 and STA1 412. At step 1, AP1 402 transmits a first PPDU to STA1 412. A MPDU within the first PPDU has a control field that includes a control ID indicating measurements and a control information field indicating the TX power of the first PPDU. STA1 412 then measures the RSSI and is then able to calculate the pathloss based on the TX power indicated by the first PPDU. At step 2, STA1 412 transmits a second PPDU to AP1 402. A second MPDU within the second PPDU has a control field that includes a control ID indicating measurements and a control information field indicating the pathloss, given that TX power was received in the first PPDU from which RSSI was measured. That is, in the case that either (1) the address of AP1 402 was included in a transmission of AP2 404 or (2) a transmission of AP2 404 immediately follows the transmission of AP1 402 and the address of AP1 402 was thereby implied.

FIG. 5D depicts an information delivery process 500D between STA1 412 and AP1 402. STA1 412 transmits a PPDU to AP1 404. A MPDU within the PPDU has a control field that includes a control ID indicating measurements and a control information field indicating the TX power of the PPDU. AP1 402 then measures the RSSI and is then able to calculate the pathloss based on the TX power indicated by the PPDU.

FIG. 5E depicts an information delivery process 500E between AP2 404 and STA2 414 and thence AP1. At step 1, AP2 404 transmits a first PPDU to STA2 414. A MPDU within the first PPDU has a control field that includes a control ID indicating measurements and a control information field indicating the TX power of the first PPDU. STA2 414 then measures the RSSI and is then able to calculate the pathloss based on the TX power indicated by first PPDU.

In this scenario, AP1 402 is not part of the wireless channel that links AP2 404 and STA2 414 (e.g., AP1 402 is in an adjacent BSS relative to the BSS AP2 404 and STA2 414 are in). Thus, in order for AP1 402 to determine the pathloss in scheme E, at step 2, the STA2 414 transmits a second PPDU addressed to AP2 404 (for identification) but intends the transmission for AP1 402. A second MPDU within the second PPDU has a control field that includes a control ID indicating measurements and a control information field indicating the pathloss, given that TX power was received in the first PPDU from which RSSI was measured. The contents of the second PPDU may be sent (1) in the clear, without a message integrity code (MIC); (2) in the clear, with a MIC that might or might not be known to AP1 402 and the key for the MIC might or might not be used for purposes other than RSSI measurements for multi-AP coordination; or (3) encrypted using a key known to AP1 402 (e.g., typically in a quality of service (QoS) null frame or something similar). Even if other MPDUs in the same AMPDU are encrypted, the pathloss-bearing frame might not be. As well AP2 404 may securely share the key for the MIC with AP1 402. At step 3, which occurs concurrently to step 2, AP1 402 sniffs the addresses of frames in the second PPDU (i.e., the address to AP2 404 and the STA2's address, and the associated pathloss.

FIG. 5F depicts an information delivery process 500F between STA2 414 and AP2 404. At step 1, STA2 414 transmits a first PPDU to AP2 404. A MPDU within the first PPDU has a control field that includes a control ID indicating measurements and a control information field indicating the TX power of the first PPDU. AP2 404 then measures the RSSI and is then able to calculate the pathloss based on the TX power indicated by first PPDU.

In this scenario, AP1 402 is not part of the wireless channel that links AP2 404 and STA2 414 (e.g., AP1 402 is in an adjacent BSS relative to the BSS AP2 404 and STA2 414 are in). Thus, in order for AP1 402 to determine the pathloss in scheme F, at step 2, the AP2 404 transmits a second PPDU addressed to STA2 414 (for identification) but intends the transmission for AP1 402. A second MPDU within the second PPDU has a control field that includes a control ID indicating measurements and a control information field indicating the pathloss, given that TX power was received in the first PPDU from which RSSI was measured. The contents of the second PPDU may be sent (1) in the clear, without a message integrity code (MIC); (2) in the clear, with a MIC that might or might not be known to AP1 402 and the key for the MIC might or might not be used for purposes other than RSSI measurements for multi-AP coordination; or (3) encrypted using a key known to AP1 402 (e.g., typically in a quality of service (QoS) null frame or something similar). Even if other MPDUs in the same AMPDU are encrypted, the pathloss bearing frame might not be. As well, AP2 404 may securely share the key for the MIC with AP1 402. At step 3, which occurs concurrently to step 2, AP1 402 sniffs the addresses of frames in the second PPDU (i.e., the address to STA2 414) and the AP2's address, and the associated pathloss.

FIG. 5G depicts an information delivery process 500G between AP1 402 and STA2 414. At step 1, AP1 402 transmits a first PPDU to STA2 414. In various embodiments, the transmission may be unprotected, integrity protected or encrypted. A MPDU within the first PPDU has a control field that includes a control ID indicating measurements and a control information field indicating the TX power of the first PPDU. STA2 414 then measures the RSSI and is then able to calculate the pathloss based on the TX power indicated by first PPDU.

At step 2, intermittently (e.g., at a controlled rate) the STA2 414 transmits either (1) a singleton MPDU in a single user (SU) PPDU or in a Uplink OFDMA-based Random Access Resource Unit (UORA RU) (or something similar), or (2) in a AMPDU where some MPDUs in the same AMPDU are encrypted and intended for AP2 404 and some MPDUs in the same AMPDU are for neighboring APs, such as AP1 402. The STA2 414 transmits the second PPDU (either as a SU PPDU or containing an AMPDU) addressed to AP1 402 (for identification) and sends the second frame (1) in the clear, without a MIC; (2) with a MIC that might be known or unknown to AP1 402; or (3) encrypted using a key known to AP1 402 (e.g., typically in a quality of service (QoS) null frame or something similar). A second MPDU within the second PPDU has a control field that includes a control ID indicating measurements and a control information field indicating the pathloss, given that TX power was received in the first PPDU from which RSSI was measured. That is, in the case that either (1) the address of AP1 402 was included in a transmission of AP2 404 or (2) a transmission of AP2 404 immediately follows the transmission of AP1 402 and the address of AP1 402 was thereby implied.

At step 3, which occurs concurrently to step 2, AP1 402 sniffs the addresses carried in the second PPDU for AP1 and STA2 (e.g., the SU PPDU, the UORA RU, or overlapping BSS (OBSS) AMPDU therein) and the associated pathloss. In some embodiments, STA2 414 includes an extra 8 bit field in the second PPDU for AP ID and sends the PPDU to its associated AP. AP1 402 is able to sniff the addresses carried in the second PPDU and the associated pathloss. In this scenario, the two APs (i.e., AP1 402 and AP2 404) will have previously exchanged AP ID information.

FIG. 5H depicts an information delivery process 500H between STA2 414 and AP1 402. STA2 414 transmits a PPDU to AP1 404. A MPDU within the PPDU has a control field that includes a control ID indicating measurements and a control information field indicating the TX power of the PPDU. AP1 402 then measures the RSSI and is then able to calculate the pathloss based on the TX power indicated by the PPDU.

FIG. 5I depicts an information delivery process 500I between AP2 404 and STA1 412. At step 1, AP2 404 transmits a first PPDU to STA1 412. In some embodiments, the first PPDU contains a QoS null frame. In various embodiments, contents in the first PPDU may be unprotected, integrity protected or encrypted. The first PPDU has a control field that includes a control ID indicating measurements and a control information field indicating the TX power of the first PPDU. STA1 412 then measures the RSSI and is then able to calculate the pathloss based on the TX power indicated by first PPDU. In some embodiments, AP1 establishes a key with STA1 412 for these purposes and passes the key to AP2 404 for encrypting or MIC-ing the first PPDU. In other embodiments, AP1 and AP2 establish a key for these purposes, and AP2 encrypts the control field received by STA1, thus STA1 412 does not obtain the transmit power so STA1 412 forwards both its RSSI and the encrypted transmit power information to AP2 404 (for identification) during step 2, AP2's transmit power the information is still encrypted, but STA1 412 relies on the AP1 402 to having the key to decrypt the transmit power of the second PPDU.

At step 2, the STA1 412 transmits a second PPDU addressed to AP2 404 (for identification) but intends the transmission for AP1 402. A second MPDU within the second PPDU has a control field that includes a control ID indicating measurements and a control information field may indicate the pathloss or may indicate encrypted transmit power and unencrypted RSSI, given that TX power was received in the first PPDU from which RSSI was measured. To help AP2 404 at the same time, the frame in the second PPDU is unencrypted or generally unencrypted. In some embodiments, the frame in the second PPDU is protected with a MIC or encrypted using a key. At step 3, which occurs concurrently to step 2, AP1 402 sniffs the addresses carried in the second PPDU (i.e., AP2 404 and STA1 412) and the associated pathloss.

FIG. 5J depicts an information delivery process 500J between STA1 412 and AP2 404. At step 1, STA1 412 transmits a first PPDU to AP2 404. In some embodiments, the first PPDU comprises a QoS null frame. In various embodiments, the first PPDU may be unprotected, integrity protected or encrypted. A MPDU within the first PPDU has a control field that includes a control ID indicating measurements and a control information field indicating the TX power of the first PPDU. AP2 404 then measures the RSSI and, assuming it can extract the transmit power, is then able to calculate the pathloss based on the TX power indicated by first PPDU. When the transmission is encrypted techniques such as are described in relation to FIG. 5I are applied.

At step 2, AP2 404 transmits either (1) a singleton MPDU in a single user (SU) PPDU or in an Uplink OFDMA-based Random Access Resource Unit (UORA RU) (or something similar), or (2) in a AMPDU where some MPDUs in the same AMPDU are encrypted and intended for AP2 404 and some MPDUs in the same AMPDU are for neighboring APs, such as AP1 402. The AP2 404 transmits the second frame addressed to STA1 412 (for identification) and sends the second frame (1) in the clear, without a MIC; (2) in the clear, with a MIC known or unknown to AP1 402; or (3) encrypted using a key known to AP1 402 (e.g., typically in a quality of service (QoS) null frame or something similar). The second frame has a control field that includes a control ID indicating measurements and a control information field indicating the pathloss, given that TX power was received in the first PPDU from which RSSI was measured. At step 3, which occurs concurrently to step 2, AP1 402 sniffs the addresses carried in the second frame (e.g., the SU PPDU, the UORA RU, or OBSS AMPDU) and the associated pathloss.

FIG. 5K depicts an information delivery process 500K between STA1 412 and STA2 414. At step 1, STA1 412 transmits a first PPDU to STA2 414. In some embodiments, the first PPDU comprises a QoS null frame. In various embodiments, the first PPDU may be unprotected, integrity protected or encrypted. A MPDU within the first PPDU has a control field that includes a control ID indicating measurements and a control information field indicating the TX power of the first PPDU. If awake, or when awake, STA2 414 measures the RSSI and is then able to calculate the pathloss based on the TX power indicated by first PPDU.

At step 2, STA2 414 transmits either (1) a singleton MPDU in a single user (SU) PPDU or in an Uplink OFDMA-based Random Access Resource Unit (UORA RU) (or something similar), or (2) in an AMPDU where some MPDUs in the same AMPDU are encrypted and intended for AP2 404 and some MPDUs in the same AMPDU are for neighboring STAs, such as STA2 414. The STA2 414 transmits the second frame addressed to STA1 412 (for identification) and sends the second frame (1) in the clear, without a MIC; (2) in the clear, with a MIC known to AP1 402; or (3) encrypted using a key known to AP1 402 (e.g., typically in a quality of service (QoS) null frame or something similar). The second frame has a control field that includes a control ID indicating measurements and a control information field indicating the pathloss, given that TX power was received in the first PPDU from which RSSI was measured. At step 3, which occurs concurrently to step 2, AP1 402 receives the addresses in the second frame and the included, associated pathloss.

FIG. 5L depicts an information delivery process 500L between STA2 414 and STA1 412. At step 1, STA2 414 transmits a first PPDU to STA1 412. In some embodiments, the first PPDU comprises a QoS null frame. In various embodiments, the first PPDU may be unprotected, integrity protected or encrypted. A MPDU within the first PPDU has a control field that includes a control ID indicating measurements and a control information field indicating the TX power of the first PPDU. If awake, or when awake, STA1 412 then measures the RSSI and is then able to calculate the pathloss based on the TX power indicated by first PPDU.

At step 2, the STA1 412 transmits a second PPDU addressed to STA2 414 (for identification). A second MPDU within the second PPDU has a control field that includes a control ID indicating measurements and a control information field indicating the pathloss, given that TX power was received in the first PPDU from which RSSI was measured. To help AP2 404 at the same time, the frame in the second PPDU is unencrypted. In some embodiments, the frame in the second PPDU is protected with a MIC or encrypted using a key. At step 3, which occurs concurrently to step 2, AP1 402 receives the addresses of the second PPDU and the included, associated pathloss.

In some embodiments, the control information fields are repeated in each MPDU for redundancy in case some MPDUs, but not others, are recovered correctly. In some embodiments, in order to send more information, different control information fields (including control information fields not related to RF parameters) are sent in different MPDUs. The sending might be prioritized based on importance/novelty since later MPDUs are more likely to get lost than earlier MPDUs. Accordingly, an exemplary pattern of transmitting the control information fields in MPDUs may be ABCABC, rather than AABBCC, wherein A has more priority than B, and B has more priority than C yet the first B has more novelty (entropy) than the second A.

In some embodiments, instead of sending pathloss or TX power and RSSI, RSSI is sent only. RSSI is then sent with the context that the RSSI was measured from the previous PPDU and either itself contains a transmit power or the PPDU was sent by the intended recipient of the frame including this RSSI. In some embodiments, related to FIG. 5F/J, instead of each AP sending a second message for each first message from a STA2 414, the AP can filter its second messages and only/mostly report the ones most at risk of OBSS interference (e.g., strongest RSSI).

Thus, to efficiently provide fast, broad RF/pathloss information to Co-SR in Wi-Fi 8, the control field formation of PPDUs can include various parameters to inform and provide context from which to interpret RF information.

### EXAMPLE CLAUSES

Implementation examples are described in the following numbered clauses:

Clause 1: A method of providing information to an access point (AP), the method comprising sending a first frame to a first wireless device, the first frame comprising a first control field indicating a first one or more parameters of the first frame, wherein at least one parameter of the first one or more parameters is associated with a transmit power of the AP; receiving a second frame from the first wireless device, wherein the second frame is carried in a physical layer protocol data units (PPDU) and comprises a second control field indicating a second one or more parameters of the first frame, wherein at least one parameter of the second one or more parameters is associated with a pathloss determined based on the at least one parameter of the first one or more parameters and a received signal strength indicator (RSSI) measured by the first wireless device; and extracting the pathloss reported in the second frame.

Clause 2: The method of clause 1, wherein the AP and the first wireless device are associated with a same basic service set (BSS).

Clause 3: The method of clause 1, wherein the AP is associated with a first basic service set (BSS) and the first wireless device is associated with a second BSS different from the first BSS.

Clause 4: The method of clause 1, wherein the first frame is protected with a message integrity code (MIC) or encrypted.

Clause 5: The method of clause 1, wherein the method further comprises intercepting a third frame, the third frame is addressed to a different AP or a different client for identification purposes but intended for the AP; and extracting a second pathloss associated with the different AP or different client reported in the third frame.

Clause 6: The method of clause 5, wherein the third frame comprises a third control field, the third control field of the third frame specifies one or more third parameters, and at least one parameter of the one or more third parameters of the third frame is associated with the second pathloss.

Clause 7: The method of clause 6, wherein the third frame is carried in a single user PPDU.

Clause 8: The method of clause 6, wherein the third frame is carried in an uplink orthogonal frequency division multiple access (OFDMA)-based random access resource unit (UORA RU).

Clause 9: The method of clause 6, wherein the third frame is part of an aggregate medium access control (MAC) protocol data unit (AMPDU), the AMPDU comprising at least one MAC protocol data unit (MPDU) intended for the AP and at least one MPDU intended for the different AP.

Clause 10: The method of clause 1, wherein the first and the second one or more parameters comprise a conducted transmit power; a radiated transmit power; a RSSI; a pathloss; and a signal-to-interference ratio (SIR).

Clause 11: The method of clause 1, wherein method further comprises receiving a plurality of frames to send to clients; and sending less than the plurality of frames to the clients based on which one or more clients of a plurality of clients are most at risk of degraded radio frequency (RF) quality due to overlapping basis service sets (BSSs).

Clause 12: A method of providing information to an access point (AP), the method comprising intercepting one or more physical layer protocol data units (PPDUs), wherein at least one frame in a PPDU of the one or more intercepted PPDUs is addressed to a different AP or a client for identification purposes but intended for the AP, each of the at least one frame in the PPDU comprises a control field, and the control field of each intercepted PPDU indicates one or more of: a conducted transmit power of an associated intercepted PPDU; a radiated transmit power of an associated intercepted PPDU; a received signal strength indicator (RSSI) of an associated intercepted PPDU; a pathloss of an associated intercepted PPDU; and a signal-to-interference ratio (SIR) of an associated intercepted PPDU.

Clause 13: The method of clause 12, wherein contents in the at least one PPDU of the one or more intercepted PPDUs is encrypted with a message integrity code (MIC).

Clause 14: The method of clause 12, wherein the one or more intercepted PPDUs are part of an aggregate medium access control (MAC) protocol data unit (AMPDU), wherein the AMPDU comprises a plurality of MAC protocol data units (MPDUs).

Clause 15: The method of clause 14, wherein the plurality of MPDUs are prioritized based on importance and entropy in decreasing priority order.

Clause 16: The method of clause 14, wherein at least one first MPDU of the plurality of MPDUs is intended for the AP and at least one second MPDU of the plurality of MPDUs is intended for the different AP.

Clause 17: The method of clause 12, wherein the at least one frame is a quality of service (QoS) null frame.

Clause 18: An access point (AP) multilink device (MLD) comprising one or more memories collectively storing instructions; and one or more processors communicatively coupled to the one or more memories, the one or more processors being individually or collectively configured to execute the instructions to cause the AP MLD to perform an operation comprising sending a first frame to a first wireless device, the first frame comprising a first control field indicating a first one or more parameters of the first frame, wherein at least one parameter of the first one or more parameters is associated with a transmit power of the AP; receiving a second frame from the first wireless device, wherein the second frame is carried in a PPDU and comprises a second control field indicating a second one or more parameters of the first frame, wherein at least one parameter of the second one or more parameters is associated with a first pathloss determined based on the at least one parameter of the first one or more parameters and a received signal strength indicator (RSSI) measured by the first wireless device; intercepting a third frame, the third frame is addressed to a different AP or a different client for identification purposes but intended for the AP; extracting the first pathloss based reported in the second frame; and extracting a second pathloss associated with the different AP or different client based on the third frame.

Clause 19: The AP MLD of clause 18, wherein the first and the second one or more parameters comprise a conducted transmit power; a radiated transmit power; a RSSI; a pathloss; and a signal-to-interference ratio (SIR).

Clause 20: The AP MLD of clause 18, wherein the operation further comprises receiving a key for decrypting the second frame or third frame prior to the sending or intercepting.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions, or multiple memories configured to collectively store data and/or instructions.

In the current disclosure, reference is made to various embodiments. However, the scope of the present disclosure is not limited to specific embodiments described. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method of providing information to an access point (AP), the method comprising:
sending a first frame to a first wireless device, the first frame comprising a first control field indicating a first one or more parameters of the first frame, wherein at least one parameter of the first one or more parameters is associated with a transmit power of the AP;
receiving a second frame from the first wireless device, wherein the second frame is carried in a physical layer protocol data units (PPDU) and comprises a second control field indicating a second one or more parameters of the first frame, wherein at least one parameter of the second one or more parameters is associated with a pathloss determined based on the at least one parameter of the first one or more parameters and a received signal strength indicator (RSSI) measured by the first wireless device; and
extracting the pathloss reported in the second frame.

2. The method of claim 1, wherein the AP and the first wireless device are associated with a same basic service set (BSS).

3. The method of claim 1, wherein the AP is associated with a first basic service set (BSS) and the first wireless device is associated with a second BSS different from the first BSS.

4. The method of claim 1, wherein the first frame is protected with a message integrity code (MIC) or encrypted.

5. The method of claim 1, wherein the method further comprises:
intercepting a third frame, the third frame is addressed to a different AP or a different client for identification purposes but intended for the AP; and
extracting a second pathloss associated with the different AP or different client reported in the third frame.

6. The method of claim 5, wherein the third frame comprises a third control field, the third control field of the third frame specifies one or more third parameters, and at least one parameter of the one or more third parameters of the third frame is associated with the second pathloss.

7. The method of claim 6, wherein the third frame is carried in a single user PPDU.

8. The method of claim 6, wherein the third frame is carried in an uplink orthogonal frequency division multiple access (OFDMA)-based random access resource unit (UORA RU).

9. The method of claim 6, wherein the third frame is part of an aggregate medium access control (MAC) protocol data unit (AMPDU), the AMPDU comprising at least one MAC protocol data unit (MPDU) intended for the AP and at least one MPDU intended for the different AP.

10. The method of claim 1, wherein the first and the second one or more parameters comprise:
a conducted transmit power;
a radiated transmit power;
a RSSI;
a pathloss; and
a signal-to-interference ratio (SIR).

11. The method of claim 1, wherein method further comprises:
receiving a plurality of frames to send to clients; and
sending less than the plurality of frames to the clients based on which one or more clients of a plurality of clients are most at risk of degraded radio frequency (RF) quality due to overlapping basis service sets (BSSs).

12. A method of providing information to an access point (AP), the method comprising:
intercepting one or more physical layer protocol data units (PPDUs), wherein at least one frame in a PPDU of the one or more intercepted PPDUs is addressed to a different AP or a client for identification purposes but intended for the AP, each of the at least one frame in the PPDU comprises a control field, and the control field of each intercepted PPDU indicates one or more of:
a conducted transmit power of an associated intercepted PPDU;
a radiated transmit power of an associated intercepted PPDU;
a received signal strength indicator (RSSI) of an associated intercepted PPDU;
a pathloss of an associated intercepted PPDU; and
a signal-to-interference ratio (SIR) of an associated intercepted PPDU.

13. The method of claim 12, wherein contents in the at least one PPDU of the one or more intercepted PPDUs is encrypted with a message integrity code (MIC).

14. The method of claim 12, wherein the one or more intercepted PPDUs are part of an aggregate medium access control (MAC) protocol data unit (AMPDU), wherein the AMPDU comprises a plurality of MAC protocol data units (MPDUs).

15. The method of claim 14, wherein the plurality of MPDUs are prioritized based on importance and entropy in decreasing priority order.

16. The method of claim 14, wherein at least one first MPDU of the plurality of MPDUs is intended for the AP and at least one second MPDU of the plurality of MPDUs is intended for the different AP.

17. The method of claim 12, wherein the at least one frame is a quality of service (QOS) null frame.

18. An access point (AP) multilink device (MLD) comprising:
one or more memories collectively storing instructions; and
one or more processors communicatively coupled to the one or more memories, the one or more processors being individually or collectively configured to execute the instructions to cause the AP MLD to perform an operation comprising:
sending a first frame to a first wireless device, the first frame comprising a first control field indicating a first one or more parameters of the first frame, wherein at least one parameter of the first one or more parameters is associated with a transmit power of the AP;
receiving a second frame from the first wireless device, wherein the second frame is carried in a PPDU and comprises a second control field indicating a second one or more parameters of the first frame, wherein at least one parameter of the second one or more parameters is associated with a first pathloss determined based on the at least one parameter of the first one or more parameters and a received signal strength indicator (RSSI) measured by the first wireless device;
intercepting a third frame, the third frame is addressed to a different AP or a different client for identification purposes but intended for the AP;
extracting the first pathloss based reported in the second frame; and
extracting a second pathloss associated with the different AP or different client based on the third frame.

19. The AP MLD of claim 18, wherein the first and the second one or more parameters comprise:
a conducted transmit power;
a radiated transmit power;
a RSSI;
a pathloss; and
a signal-to-interference ratio (SIR).

20. The AP MLD of claim 18, wherein the operation further comprises receiving a key for decrypting the second frame or third frame prior to the sending or intercepting.
